(19) United States
(12) Patent Application Publication
(10) Pub. No.: US 2025/0341126 A1
(43) Pub. Date: Nov. 6, 2025

(54) APPARATUS AND METHOD FOR INSTALLING A CLOSURE IN A BUILDING

(71) Applicant: SANO DEVELOPMENT LIMITED, Wilmslow (GB)

(72) Inventors: David Lee JONES, Wilmslow (GB); Edward Ross SHENTON, Wilmslow (GB); Robert ORR, Wilmslow (GB)

(73) Assignee: SANO DEVELOPMENT LIMITED, Wilmslow (GB)

(21) Appl. No.: 18/851,544

(22) PCT Filed: Mar. 28, 2023
(86) PCT No.: PCT/EP2023/058009

§ 371 Date: Sep. 26, 2024

(30) Foreign Application Priority Data
Mar. 29, 2022 (GB) 2204480.4
Mar. 29, 2022 (GB) 2204481.2
Mar. 29, 2022 (GB) 2204483.8
Mar. 23, 2023 (GB) 2304251.8

(51) Int. Cl. E06B 1/02

(52) U.S. Cl. CPC E06B 1/02

(57) ABSTRACT

A sealing frame for mounting a closure within an aperture in a building. The mounting frame comprises a main frame structure and a sealing component. The main frame structure is arranged so that, in use, the main frame structure extends around a perimeter of the building aperture. The sealing component is for a closure frame of the closure, the sealing component extending, in use, away from the main frame structure and into the building aperture. In one embodiment first and second sealing surfaces are defined by the sealing frame which face in the same direction and are offset from one another along the depth axis of the building aperture. In another embodiment either a frame seal is provided on the sealing component to seal to a closure frame or the sealing frame further comprises a mounting flange having a building seal to seal to the building. In another embodiment a first portion of the main frame structure extends along a depth axis of the building aperture to close a cavity formed between inner and outer building layers and the main frame structure defines a second sealing surface which is adapted to abut a building surface for sealing the sealing frame to the building around the perimeter of the building aperture.

### TECHNICAL FIELD

The present invention relates to an apparatus and method for installing a closure within an aperture in a building. The term “closure” is used generically in this document to refer to a window or a door or anything that closes off an opening or aperture in a building. Particular embodiments are presented in the detailed description referring to windows, window frames and window apertures in a building (in a wall or roof of the building) however in each instance this should not be considered to be limiting and the present invention in all cases encompasses doors and windows (and mounting frames for frames of doors and windows) unless the context specifically requires otherwise. The present invention also relates to an apparatus and method for sealing of a closure frame (such as a window frame) within an aperture in a building, and a method of renovating a building involving the removal of an existing door or window and the installation of a replacement door or window.

### BACKGROUND

In the construction industry, it is well-known that the energy efficiency of buildings can be improved using construction materials and components having good thermal insulating properties. In particular, significant improvements in the energy efficiency of buildings have been achieved through the use of double and triple-glazed window and door units, mounted in polymeric or composite window or door frames having low thermal transmission rates. These have been shown to greatly reduce thermal losses through apertures of buildings, in comparison to prior single-glazed units, mounted in plain wooden or metal frames.

However, the ultimate thermal efficiency of a window or door depends upon other factors, including the way in which the frame is installed in its aperture. It is important that the frame be mounted in the aperture in such a way that the passage of air between the frame and a wall or roof structure in which the frame is mounted is restricted, as this could otherwise permit egress of warm air from the building, and ingress of cold external air. This has been achieved by sealing the frame to a structure of the building surrounding the aperture. In recent years, dedicated adhesive-backed sealing tapes have been developed for this purpose.

The window or door frame is first installed in the aperture resting on blockwork of the wall structure, such as bricks or cement blocks. Any cavity between internal and external wall skins is typically filled using a suitable insulating material, of which many types exist. The frame is sealed to the blockwork using the adhesive tape, which extends over surfaces of blocks adjacent the frame and on to an internal surface of the frame itself. The tape overlaps an interface between the blocks and the frame, restricting the passage of air (and moisture) around the frame. The tape itself is normally supplied in a long roll. Taping of the frame is relatively complicated, particularly at its corner regions.

Other options include positioning a membrane around the perimeter of the frame overlapping the block-frame interface, securing the membrane in place using staples or other mechanical fixations, and then taping the membrane to the frame in corner regions and at other potential leak points. This approach may be more common where a simple wooden frame is positioned in the aperture, to which the membrane can be secured.

As is well-known however, modern window and door systems of this type have a limited lifetime. For example, glazed units can deteriorate and require replacing, and polymeric materials used to form the frames can deteriorate over time, particularly through exposure to UV light. Consequently, a time comes when the window or door requires replacing. Whilst this is a relatively straightforward process, problems can occur in correctly sealing a new window frame within the window aperture.

In particular, it can be difficult to effectively seal the new frames to the building blockwork. This is because, in the process of removing an old polymeric or composite frame, it is necessary to cut the sealing tape (or tape and membrane) positioned at the interface between the blocks and the frame. A portion of the tape remains in place, trapped beneath window framing boards (typically plaster based or wooden) which provide a decorative finish in the window or door reveal area. It is not possible to tape the replacement frame in the same way, because the tape would necessarily have to be positioned over the top of the decorative structure in the reveal area.

Consequently, the only cost-effective way in which a seal can be achieved is by using a flowable sealant such as a viscous time-setting silicone material, which is applied to the block-frame interface. Decorative finishing strips are then positioned over the sealant on the framing boards. A similar sealant is also applied to the external surface of the frame, to provide a primary barrier against air and water ingress at the external perimeter of the frame. This can be challenging as the sealant is applied directly to the outer surface of the blocks, which are often rough and uneven. The block surfaces and the sealant also tend to degrade over time. Degrading of the sealant or its bond to the blocks, and/or incorrect application of the sealant, can therefore lead to air flow past the frame, and potentially water ingress.

Separately, it is known to employ so-called ‘cavity closers’ when constructing a building comprising internal and external wall skins. The cavity closer is locatable within the cavity so that it extends around the perimeter of a window aperture. The primary function of a cavity closer is to bridge the cavity between the internal and external wall skins (which can be comparatively large in modern buildings), and to provide a mounting surface for the window or door frame. However, it remains necessary to seal the frame to the cavity closer, which is again achieved using tape (or membrane and tape) as described above, and thus the same problems arise. In addition, whilst the cavity closer can provide a surface to which the frame may be secured, precise positioning of the frame relative to the closer—which is necessary to achieve an effective seal—can be challenging.

Similar issues can arise in connection with replacement windows and doors for other building types, such as those comprising a timber-frame structural core.

It is an aim of certain examples of the present invention to solve, mitigate or obviate, at least partly, at least one of the problems and/or disadvantages associated with the prior art. Certain examples aim to provide at least one of the advantages described below.

### BRIEF SUMMARY OF THE INVENTION

According to a first aspect of the present invention there is provided a sealing frame for sealing a closure within an aperture in a building, the sealing frame comprising: a main frame structure arranged so that, in use, the main frame structure extends around a perimeter of the building aperture; a sealing component for a closure frame of the closure, the sealing component extending, in use, away from the main frame structure and into the building aperture and comprising a first sealing surface facing in a first direction along a depth axis of the building aperture and which is adapted to abut a surface of the closure frame, for sealing the closure frame relative to the main frame structure and so the closure relative to the building; and a mounting flange adapted to abut a building surface for locating the sealing frame in the building aperture, the mounting flange defining a second sealing surface facing in the first direction along the depth axis of the building aperture; wherein the first and second sealing surfaces are offset from one another along the depth axis of the building aperture.

The first sealing surface may be adapted to abut a rear-facing surface of the closure frame. The sealing frame may further comprise: a frame seal for sealing the closure frame relative to the sealing frame, the frame seal being provided on the first sealing surface. The frame seal may be mounted on the sealing component and bonded to it; or the frame seal may be provided integrally with the sealing component.

The second sealing surface may be adapted to abut a surface of a building structure surrounding the building aperture. The mounting flange defines an abutment surface adapted to abut a surface of the building structure, and the sealing frame may be adapted to overlap an internal edge of the closure aperture defined between the surface of the building structure and a generally perpendicular surface in a reveal area of the building aperture. The sealing frame may further comprise: a building seal for sealing the mounting flange to a surface of a building structure surrounding the building aperture, the building seal being provided on the second sealing surface. The building seal may be mounted on the mounting flange and bonded to it; or the building seal may be provided integrally with the mounting flange.

According to a second aspect of the present invention there is provided a sealing frame for sealing a closure within an aperture in a building, the sealing frame comprising: a main frame structure arranged so that, in use, the main frame structure extends around a perimeter of the building aperture; and a sealing component for a closure frame of the closure, the sealing component extending, in use, away from the main frame structure and into the building aperture and comprising a first sealing surface which is adapted to abut a surface of the closure frame, for sealing the closure frame relative to the main frame structure and so the closure relative to the building; wherein the sealing frame further comprises a mounting flange adapted to abut a building surface for locating the sealing frame in the building aperture and defining a second sealing surface, the mounting flange having a building seal provided on the second sealing surface for sealing the sealing frame relative to the building; or wherein the sealing frame further comprises a frame seal for sealing the closure frame relative to the sealing frame, the frame seal being provided on the first sealing surface.

The first and second sealing surfaces may face in a first direction along a depth axis of the building aperture and may be offset from one another along the depth axis of the building aperture.

The first sealing surface may be adapted to abut a rear-facing surface of the closure frame. The frame seal may be mounted on the sealing component and bonded to it; or the frame seal may be provided integrally with the sealing component.

The second sealing surface may be adapted to abut a surface of a building structure surrounding the building aperture. The mounting flange may define an abutment surface adapted to abut a surface of the building structure, and the sealing frame may be adapted to overlap an internal edge of the closure aperture defined between the surface of the building structure and a generally perpendicular surface in a reveal area of the building aperture. The building seal may be mounted on the mounting flange and bonded to it; or the building seal may be provided integrally with the mounting flange.

According to a third aspect of the present invention there is provided a sealing frame for sealing a closure within an aperture in a building, the sealing frame comprising: a main frame structure arranged so that, in use, the main frame structure extends around a perimeter of the building aperture and defines a first portion extending along a depth axis of the building aperture in which the sealing frame is to be installed; and a sealing component for a closure frame of the closure, the sealing component extending, in use, away from the first portion of the main frame structure and into the building aperture, and comprising a first sealing surface adapted to abut a surface of the closure frame, for sealing the closure frame relative to the main frame structure and so the closure relative to the building; wherein the first portion of the main frame structure is configured to close a cavity formed between inner and outer building layers; and wherein the main frame structure defines a second sealing surface which is adapted to abut a building surface for sealing the sealing frame to the building around the perimeter of the building aperture.

The cavity may comprise an insulating cavity between inner and outer building layers. The cavity may be at least partially filed with an insulating material.

The first sealing surface may be adapted to abut a surface of the closure frame on a first side of the sealing component and an internal surface of the first portion of the main frame structure on a second side of the sealing component comprises a closure reveal component arranged in use to be positioned within the building aperture. The closure reveal component may be configured to receive a finishing material, finishing panel or finishing strip.

The main frame structure may comprise a mounting flange adapted to abut a building surface for locating the sealing frame in the building aperture; and the mounting flange may define the sealing surface and a building seal is provided on the mounting flange for sealing the sealing frame relative to the building. The building seal may be mounted on the mounting flange and bonded to it; or the building seal may be provided integrally with the mounting flange.

The sealing surface may comprise a second sealing surface; and the sealing component may comprise a first sealing surface for sealing the closure frame relative to the main frame structure and so the closure relative to the building. The first and second sealing surfaces may face in a first direction along a depth axis of the building aperture and may be offset from one another along the depth axis of the building aperture.

The first sealing surface may be adapted to abut a rear-facing surface of the closure frame.

The sealing frame may further comprise: a frame seal for sealing the closure frame relative to the sealing frame; wherein the frame seal is mounted on the sealing component and bonded to it; or wherein the frame seal is provided integrally with the sealing component.

According to a fourth aspect of the present invention there is provided a two-piece closure assembly comprising: a closure frame; and a sealing frame as described above.

According to a fifth aspect of the present invention there is provided a building comprising a sealing frame as described above, in which the sealing frame is permanently secured to the building.

According to a sixth aspect of the present invention there is provided a method of installing a closure within an aperture of a building, the method comprising the steps of: positioning a sealing frame as described above within the building aperture; inserting a closure frame into an opening of the building aperture; translating the closure frame along a depth axis of the building aperture in a direction away from the opening to a mounting location at which a surface of the closure frame contacts an abutment surface defined by the sealing component; and securing the closure frame to the building at the mounting location.

According to a seventh aspect of the present invention there is provided a method of renovating a building involving the replacement of a closure installed within an aperture of a building, the method comprising the steps of: removing a closure frame from its location within the building aperture; positioning a sealing frame as described above within the building aperture; inserting a replacement closure frame of a replacement closure into an opening of the building aperture; translating the replacement closure frame along a depth axis of the building aperture in a direction away from the opening to a mounting location at which a surface of the replacement closure frame contacts an abutment surface defined by the sealing component; and securing the replacement closure frame to the building at the mounting location.

According to a eighth aspect of the present invention there is provided a method of renovating a building involving the replacement of a closure which has been installed within an aperture of a building employing above described installation method, the method comprising the steps of: removing the closure frame from its location within the building aperture; inserting a replacement closure frame of a replacement closure into the opening of the building aperture; translating the replacement closure frame along a depth axis of the building aperture in a direction away from the opening to the mounting location, at which a surface of the replacement closure frame contacts the abutment surface defined by the sealing component; and securing the replacement closure frame to the building at the mounting location.

Optionally, the closure comprises a window, the closure frame comprises a window frame and the building aperture comprises a window aperture.

### BRIEF DESCRIPTION OF THE DRAWINGS

Examples of the invention are further described hereinafter with reference to the accompanying drawings, in which:

FIG. 1 is a perspective view of a mounting frame for mounting a window within a window aperture in a building, according to an embodiment of the present invention;

FIG. 2 is a cross-sectional side view of the mounting frame shown in FIG. 1, drawn to a larger scale, sectioned in a direction along a depth dimension of the mounting frame, with certain features of the frame removed for ease of illustration;

FIG. 3 is a perspective view of a building in the form of a house, comprising windows which have been fitted in window apertures employing the mounting frame of FIG. 1, with a roof and some walls of the building removed, for illustration purposes;

FIG. 4 is a cross-sectional side view of a wall of the building shown in FIG. 3, drawn to a larger scale and sectioned in a vertical plane through one of the windows, showing the mounting frame and the window located in a window aperture of the wall;

FIG. 5 is a cross-sectional side view of a mounting frame according to another embodiment of the present invention, which is similar to the mounting frame of FIG. 2, shown sectioned in a direction along a depth dimension of the mounting frame and with certain features of the frame removed, for ease of illustration;

FIG. 6 is a cross-sectional side view of a mounting frame according to a further embodiment of the present invention, which is similar to the mounting frame of FIG. 2, shown sectioned in a direction along a depth dimension of the mounting frame and with certain features of the frame removed, for ease of illustration;

FIG. 7 is a cross-sectional side view of a mounting frame according to a still further embodiment of the present invention, which is similar to the mounting frame of FIG. 2, shown sectioned in a direction along a depth dimension of the mounting frame and with certain features of the frame removed, for ease of illustration;

FIG. 8 is a cross-sectional plan view of the mounting frame shown in FIG. 7, sectioned in a horizontal plane across a width dimension of the frame;

FIG. 9 is a front view of an elongate mounting bracket which can be used to secure the window frame shown in FIG. 4 to the building;

FIG. 10 is a front view of an alternative bracket of similar construction to that shown in FIG. 9;

FIG. 11 is a cutaway perspective view of a mounting frame in accordance with a still further embodiment of the present invention, which is similar to the mounting frame of FIG. 2, with certain features of the frame removed, for ease of illustration;

FIG. 12 is a cutaway perspective view of a mounting frame in accordance with a still further embodiment of the present invention, which is similar to the mounting frame of FIG. 2, with certain features of the frame removed, for ease of illustration;

FIGS. 13a to 13c are variations of the mounting frame of FIG. 12; and

FIG. 14 is a cutaway perspective view of a mounting frame in accordance with a still further embodiment of the present invention, which is similar to the mounting frame of FIG. 2, with certain features of the frame removed, for ease of illustration.

### DETAILED DESCRIPTION

There is disclosed herein a mounting frame for mounting a window or a door (generically, a closure) within an aperture in a building. In the following description the terms “window”, “window frame” and “window aperture” are used, though the skilled person will understand that the word “door” or the word “closure” may be substituted for “window”. The term closure means that the window or door closes off an opening or aperture in the building. It will be appreciated that doors are openable and closable through a hinge or sliding mechanism, whereas windows can be openable and closable or fixed (permanently closed). Either way, the term “closure” refers to something that can close an aperture or opening either permanently or can be opened and closed.

The mounting frame comprises: a main frame structure extending around a perimeter of the window aperture; and a mount for a window frame of the window, the mount extending, in use, away from the main frame structure and into the window aperture, and comprising an abutment surface adapted to abut a surface of the window frame, to thereby define a mounting location for the window frame within the window aperture.

The main frame structure may comprise top, bottom, left side and right side parts arranged in use around the perimeter of a window aperture.

Alternatively, the mounting frame may be termed a sealing frame for sealing a window aperture in a building. Similarly, the mount may be termed a sealing component comprising a sealing surface for abutting the window frame and comprising a sealing surface for sealing the window frame relative to the main frame structure and so the window is sealed relative to the building. In the following description, the terms “mounting” and “sealing” and similarly the terms “mount” and “sealing component” should be considered to be interchangeable except where the context requires otherwise.

The window aperture will typically be an aperture in a wall of the building. However, the principles of the present invention may be applied to a window aperture in other structural features of the building, such as in a roof structure of the building. The abutment surface may be adapted to abut a rear-facing surface of the window frame.

The mounting frame, in particular the mount, may advantageously define a fixed mounting location for the window frame. This may facilitate both initial positioning of the window frame within the window aperture (at a correct position), and subsequent installation of a replacement window frame in the aperture should renovation be required. In particular, the mount may serve to restrict movement of a window frame relative to the aperture during the installation procedure, to define the mounting location for the window frame. The mounting location will typically be between inner and outer surfaces of the building structure, which may for example be defined by a wall or walls of the building.

The mounting frame may be of a polymeric material, such as plasticised polyvinylchloride (UPVC), which is frequently used in window frame manufacture. However, other materials could be employed, including but not limited to metals, metal alloys, wood and wood composites, and other composite materials such as glass-fibre based composites.

An installation procedure for the window may involve positioning the mounting frame in the window aperture, and then securing of the mounting frame to the building, for example to blockwork of a wall of the building or a timber frame structure defining a wall. The window frame is then inserted into an opening of the aperture (typically an outer opening) and translated along the aperture until the surface (suitably the rear or inwardly facing surface) of the window frame abuts the abutment surface of the mount. The window frame will then be in the correct, installed position. The mount, and in particular its abutment surface, may be located at that position (thereby defining the mounting location), and may act to restrict further translation of the window frame along the aperture in a direction away from said opening. An operator installing the window frame will therefore be provided with a positive indication that the window frame surface is in the correct position when its surface comes into contact with the abutment surface of the mount. The window frame can also be sealed relative to the mount (in particular its abutment surface) using a suitable seal and/or sealing material, as will be described in more detail below.

The arrangement by which the abutment surface abuts the surface of the window frame may advantageously enable a compressive loading to be applied to such a seal/sealing material. This may be achieved by imparting a load on the window frame during installation causing the seal/sealing material to be compressed, and then anchoring the window frame to the building (e.g. a wall) so that the compressive load is maintained. This may provide a much-improved seal bond in comparison to prior systems including those employing a cavity closer.

The mounting frame of the present invention may be used to replace closures such as doors and windows. In some cases, a building aperture that accommodated a door may be converted into a window or vice versa. Either way, the original closure is removed, a mounting frame installed, and the new closure inserted. In the case of a replacement window, an existing window frame is firstly removed from the window aperture. This may require that any external and/or internal sealant be removed or cut away, and that any mounting tape used to seal the window frame to the building (or tape and membrane if used) be severed. The replacement window frame can then be inserted into the aperture and positioned in abutment with the abutment surface of the mount, following the procedure described above. In a similar fashion therefore, the installer may be provided with a positive indication that the replacement frame has been located in the correct position, when the surface (suitably the rear-facing surface) of the replacement frame abuts the surface of the mount.

The main frame structure may extend around an entire perimeter, or substantially an entire perimeter, of the window aperture. The main frame structure may advantageously provide a secure mounting for the window frame around its entire perimeter, and may optionally provide for sealing of the window frame around its entire perimeter.

The mount may be provided integrally with the main frame structure. The mount and the main frame structure may therefore be unitary or one-piece. Alternatively, the mount may be provided as a separate component and may be coupled to the main frame structure, and may for example be bonded or secured with a mechanical fixing. The main frame structure may comprise a coupling component or feature, such as a channel, slot, groove or the like, the coupling component adapted to receive the mount for coupling the mount to the main frame structure. A plurality of coupling components may be provided, which may be spaced apart along the main frame structure, for example along a dimension of the main frame structure (such as along a depth of the structure extending from front to back, considered relative to the window aperture once the mounting frame is installed). The coupling components may each provide a separate mounting location for the mount and so for the window frame. Advantageously therefore, the mounting frame may be capable of providing more than one possible mounting location for the mount, which may facilitate use of the mounting frame with window frames of different types (for example, having different dimensions such as frame depth), and/or may provide for a degree of adjustment to the position of the window frame in the aperture during installation. The mount may comprise a plurality of mount parts which together form the assembled mount. This may facilitate location of the mount in a selected one of the coupling components. Each mount part may be adapted to be coupled to a different frame part of the mounting frame structure.

The mount may comprise a plurality of generally elongate protrusions (such as lips, ribs, arms, fingers or the like) which may together form the mount. Each frame part may comprise a respective such protrusion, and the protrusions may together form the mount. Thus the mount may comprise a top protrusion, a bottom protrusion, a left side protrusion and a right side protrusion. The elongate protrusions may each extend in a direction along a main length of the respective frame part. The mount may extend continuously, or substantially continuously, in a direction around the perimeter of the main frame structure.

The frame parts forming the main frame structure may be provided as separate components, and may be coupled together to form the frame. This may provide the advantage that a mounting frame of a desired shape and/or dimensions can easily be formed by selecting frame parts of appropriate dimensions, and/or by cutting the frame parts to the required lengths. The frame parts may be bonded together.

The mounting frame may comprise a plurality of different mounts, and may comprise a kit of mounts comprising two or more different mounts. At least one parameter of a first mount of the kit may differ from the corresponding parameter of a further one or more mount of the kit. A selected parameter may be a height of the mounts, which may determine the extent to which the mounts extend from the main frame structure into the window aperture. A selected parameter may be an angle of the abutment surface defined by the mount, considered relative to the main frame structure and/or to a main axis of the window aperture.

The main frame structure may comprise an inner peripheral surface which may, in use, face towards the window aperture. The inner peripheral surface may be defined by inner surfaces of the frame parts forming the main frame structure. The inner peripheral surface may communicate with the aperture, and/or may open on to the aperture. The inner peripheral surface may be substantially planar. The inner peripheral surface may be adapted to receive a finishing panel or panels, which may be secured to the mounting frame following positioning of the window frame at its mounting location. The finishing panel(s) may be decorative and/or may provide a surface to which a decorative coating (such as a cementitious plaster material) can be applied. The mount may extend out of or away from the inner peripheral surface.

The main frame structure may comprise an outer peripheral surface which may, in use, face away from the window aperture towards a building structure (e.g. a wall structure) surrounding the window aperture, which structure may define the aperture. The outer peripheral surface may be defined by outer surfaces of the frame parts forming the main frame structure.

The abutment surface of the mount may extend in a direction which is substantially perpendicular to the main frame structure. This may provide an effective abutment for the window frame, and so secure positioning of the window frame in the aperture. It may also or alternatively facilitate sealing of the window frame to the mounting frame, as will be discussed in more detail below. The abutment surface may extend, in use, in a direction which is substantially perpendicular to a main axis of the aperture, which axis may extend along the aperture from an external opening to an internal opening of the aperture. It may be desirable to provide an abutment surface which is inclined, and so at a non-parallel angle relative to a line which is perpendicular to the main frame structure and/or to the main axis of the window aperture. The angle of inclination which is selected may be dependent upon a shape or profile of the surface of the window frame, for example if the window frame includes a bevelled or inclined portion adjacent an outer perimeter of the window frame. It will be understood here that the reference to the rear-facing surface of the window frame is to that which faces inwardly, towards the interior of the building.

The mounting frame may be adjustable. At least one dimension of the mounting frame may be adjustable. A dimension of the mounting frame which can be adjusted may be a depth of the frame, which may be considered in a direction along the axis of the window aperture. This may facilitate adjustment of the mounting frame to suit e.g. building walls having different depths, and may provide for adjustment to account for variations in building practices such as cavity depths between inner and outer wall skins. The mounting frame structure may comprise a first frame component and a second frame component, which components may be arranged to be coupled together to form the main frame structure. The first frame component may be mountable for movement relative to the second frame component, which may facilitate said adjustment. One of the first and second frame components may be an outer frame component and the other one of the first and second frame components may be an inner frame component. The outer frame component may be adapted to receive the inner frame component so that a position of the inner frame component relative to the outer frame component can be adjusted. The inner frame component may be mountable within the outer frame component, and may be mounted for sliding movement relative to the outer frame component. The mounting frame structure may be generally telescopic. In particular, the inner frame component may be telescopically mounted within the outer frame component.

The mounting frame may comprise an insulation material, which may cover at least part of an outer peripheral surface of the main frame structure. The insulation material may comprise at least one insulation component, which may be of a substantially rigid material such as a polymeric foam, and the insulation component may be mounted to one or more frame part of the main frame structure. Optionally, the top frame part is free from insulation material. It may not be necessary to provide insulation over the top frame part as a lintel of a window in a wall (which in part defines the aperture) typically incorporates insulation.

The mounting frame may comprise a mounting component for locating the mounting frame on the building, such as on a wall of the building. The mounting component may be or may comprise a mounting plate, flange, lip, or the like, which may be adapted to abut a surface of the building such as a wall surface. The mounting component may define an abutment surface adapted to abut the building surface. The main frame structure may define or may comprise the mounting component. The mounting frame may be adapted to overlap an edge of a structure of the building such as a wall, which may be an internal edge defined between an internal (typically vertical) surface of the wall and a generally perpendicular surface in the window reveal. In use, the mounting frame may pass over the edge so that the mounting component is disposed, in use, on the internal surface of the wall. The mounting frame, in particular its main frame structure, may be generally L-shaped in cross-section (taken in a depth direction of the frame from front to back). The main frame structure may comprise a window reveal component adapted to reside within the window aperture, and the mounting component. A part of the L-shape may be defined by the window reveal component and a part by the mounting component.

The mounting frame may comprise a frame seal adapted to abut the surface of the window frame, for sealing the window frame relative to the main frame structure, and so the window relative to the building. The frame seal may be mounted on or coupled to the mount (also referred to herein as the sealing component), and may be bonded to the mount (for example using a suitable adhesive). The frame seal may be provided integrally with and/or formed by the mount (for example the seal may be over-moulded on the mount, particularly where the mount is of a polymeric material). The frame seal may be of an elastomeric or rubber material, and may be a sealing strip or the like. The frame seal may define at least part of the abutment surface of the mount, and may be provided on a core structure of the mount.

Other options for the frame seal exist, including that the seal is a bead of time-setting sealant material applied to the mount, and/or to the window frame, prior to mounting of the window frame in abutment with the mount. Suitable options for the sealant material include viscous silicone-based sealants.

The mounting frame may comprise a building seal adapted to abut a surface of the building such as a wall, for sealing the mounting frame relative to the building surface, and so the window frame relative to the building surface (once the window frame is positioned in the aperture). The building seal may be mounted on or coupled to the main frame structure, and may be bonded to the main frame structure (for example using a suitable adhesive). The building seal may be provided integrally with and/or formed by the main frame structure, (for example the seal may be over-moulded on the main frame structure, particularly where the structure is of a polymeric material). The seal may be of an elastomeric or rubber material, and may be a sealing strip or the like. The building seal may be on the mounting component.

Other options for the building seal exist, including that the seal is a bead of time-setting sealant material applied to the main frame structure, and/or to the building, prior to positioning of the mounting frame in the window aperture. Suitable options for the sealant material include viscous silicone-based sealants.

Parts of the mounting frame of the first aspect of the invention which are common to parts of the sealing frame of the second aspect defined below may have any of the further features defined in or with respect to the second aspect or elsewhere in this document. In particular, the mount may form or may comprise a sealing component defining a sealing surface which is adapted to abut the surface of the window frame, for sealing the window frame relative to the main frame structure and so the window relative to the building. The abutment surface may also define the sealing surface.

The mount may comprise one or more access zone or area, which may provide a pathway or passage that can receive a mounting bracket or the like for the window frame, for mounting the window frame within the window aperture (e.g. to blockwork of the building). The access zone or area may permit passage of the bracket from the window frame through or past the mount, for connection to the building. The access zone may be defined by a removable wall portion of the mount, for example in a core structure of the mount. The removable wall portion may be removable by twisting, snapping, or punching it out to break the connection between the wall portion and the remainder of the mount. The removable wall portion may have a reduced depth relative to a remainder or main portion of the mount. The depth may be taken in a depth direction of the frame, from front to back. The removable wall portion may be frangible. This may be achieved by providing the wall portion with a line or lines of weakness, for example at or near a perimeter of the wall portion. The line(s) of weakness may allow the connection between the wall portion and the remainder of the mount to be easily broken. The removable wall portion may define part of the abutment surface of the mount. The access zone (or at least one zone) may be an aperture in the mount.

Where the mounting frame comprises a sealing frame and the mount comprises a sealing component, the sealing component may advantageously seal the main frame structure relative to the window frame when the window frame is installed in the window aperture. The provision of the sealing frame, comprising the sealing component, may avoid a requirement to seal the window frame relative to the building using tape (or membrane and tape) as described above. This may reduce installation time/costs, and may facilitate a subsequent renovation involving removal of the window frame and installation of a window frame of a replacement window.

The sealing component may be provided integrally with the main frame structure. The sealing component and the main frame structure may therefore be unitary or one-piece. Alternatively, the sealing component may be provided as a separate component and may be coupled to the main frame structure, and may for example be bonded or secured with a mechanical fixing. The main frame structure may comprise a coupling component or feature, such as a channel, slot, groove or the like, the coupling component adapted to receive the sealing component for coupling the sealing component to the main frame structure. A plurality of coupling components may be provided, which may be spaced apart along the main frame structure, for example along a dimension of the main frame structure (such as along a depth of the structure extending from front to back, considered relative to the window aperture once the mounting frame is installed). The coupling components may each provide a separate mounting location for the sealing component. Advantageously therefore, the mounting frame may be capable of providing more than one possible mounting location for the sealing component, which may facilitate use of the mounting frame with window frames of different types (for example, having different dimensions such as frame depth). The sealing component may comprise a plurality of seal parts which together form the assembled sealing component. This may facilitate location of the sealing component in a selected one of the coupling components. Each seal part may be adapted to be coupled to a different frame part of the mounting frame structure.

The sealing component may comprise a plurality of generally elongate protrusions (such as lips, ribs, arms, fingers, or the like) which may together form the sealing component. Each frame part may comprise a respective protrusion, and the protrusions may together form the sealing component. Thus the sealing component may comprise a top protrusion, a bottom protrusion, a left side protrusion and a right side protrusion. The elongate protrusions may each extend in a direction along a main length of the respective frame part. The sealing component may extend continuously, or substantially continuously, in a direction around the perimeter of the main frame structure.

The mounting frame may comprise a plurality of different sealing components, and may comprise a kit of sealing components comprising two or more different sealing components. At least one parameter of a first sealing component of the kit may differ from the corresponding parameter of a further one or more sealing component of the kit. A selected parameter may be a height of the sealing component, which may determine the extent to which the sealing component extends from the main frame structure into the window aperture. A selected parameter may be an angle of the sealing component, considered relative to the main frame structure and/or to a main axis of the window aperture. A selected parameter may be a profile of the sealing component.

The sealing component may extend in a direction which is substantially perpendicular to the main frame structure. This may provide an effective seal against the window frame. The sealing component may extend, in use, in a direction which is substantially perpendicular to a main axis of the aperture, which axis may extend along the aperture from an external opening to an internal opening of the aperture. It may be desirable to provide a sealing component which is inclined, and so at a non-parallel angle relative to a line which is perpendicular to the main frame structure and/or to the main axis of the window aperture. The angle of inclination which is selected may be dependent upon a shape or profile of the surface of the window frame.

The sealing component may comprise or may define a frame seal, and the frame seal may define the sealing surface. The frame seal may be mounted on or coupled to the sealing component, and may be bonded to the sealing component (for example using a suitable adhesive). The frame seal may be provided integrally with and/or may be formed by the sealing component (for example the seal may be over-moulded on the sealing component, particularly where the sealing component is of a polymeric material). The frame seal may be of an elastomeric or rubber material, and may be a sealing strip or the like.

Parts of the sealing frame of the second aspect of the invention which are common to parts of the above described mounting frame may have any of the further features defined above or elsewhere in this document. In particular, further features of the main frame structure of the sealing frame may have any of the further features of the main frame structure of the mounting frame. The sealing component may provide a mount for the window frame having any of the further features of the mount defined in or with respect to the first aspect or elsewhere in this document (thus the sealing component may in some respects be considered equivalent to the mount).

There is further disclosed a mounting frame for mounting a window within a window aperture in a building and sealing the window relative to the building, the mounting frame comprising: a main frame structure comprising top, bottom, left side and right side frame parts which are arranged so that, in use, the main frame structure extends around a perimeter of the window aperture; and a mount for a window frame of the window, the mount extending, in use, away from the main frame structure and into the window aperture; in which the mount comprises an abutment surface adapted to abut a surface of the window frame to define a mounting location for the window frame within the window aperture, the abutment surface being configured to seal the window frame relative to the main frame structure and so the window relative to the building.

There is further disclosed a two-piece window assembly comprising: a window frame; and a mounting frame or sealing frame as described above.

There is further disclosed a method of installing a window within a window aperture of a building, the method comprising the steps of: positioning a mounting frame within the window aperture; arranging a main frame structure of the mounting frame, comprising top, bottom, left side and right side frame parts, so that the main frame structure extends around a perimeter of the window aperture; arranging a mount of the mounting frame so that it extends from the main frame structure and into the window aperture; inserting a window frame of the window into an opening of the aperture; and translating the window frame along the aperture in a direction away from the opening to a mounting location at which a surface of the window frame contacts an abutment surface defined by the mount; and securing the window frame to the building at the mounting location.

There is further disclosed a method of renovating a building involving the replacement of a window installed within a window aperture of the building, the method comprising the steps of: removing a window frame of the window from its location within the window aperture; positioning a mounting frame within the window aperture; arranging a main frame structure of the mounting frame, comprising top, bottom, left side and right side frame parts, so that the main frame structure extends around a perimeter of the window aperture; arranging a mount of the mounting frame so that it extends from the main frame structure and into the window aperture; inserting a window frame of a replacement window into an opening of the aperture; and translating the replacement window frame along the aperture in a direction away from the opening to a mounting location at which a surface of the replacement window frame contacts an abutment surface defined by the mount; and securing the window frame to the building at the mounting location.

The method may comprise the further step of removing a decorative surface finish disposed within the aperture adjacent the window frame prior to positioning of the mounting frame within the aperture, and optionally prior to removal of the existing window frame. The decorative surface finish may comprise panels (such as of a plaster, wood and/or plastics material) positioned in the aperture such as in a window reveal area, and/or any cementitious finishing material. Removing a decorative surface finish may enable positioning of the mounting frame directly on to building structural features such as blockwork of a wall.

There is further disclosed a method of renovating a building involving the replacement of a window which has been installed within a window aperture of a building employing the above described installation method, the method comprising the steps of: removing the window frame from its location within the window aperture; inserting a window frame of a replacement window into the opening of the aperture; and translating the replacement window frame along the aperture in a direction away from the opening to the mounting location, at which a surface of the replacement window frame contacts the abutment surface defined by the mount; and securing the replacement window frame to the building at the mounting location.

There is further disclosed a mounting frame for mounting a window within a window aperture in a building, the mounting frame comprising: a main frame structure configured to receive a window frame of the window, the main frame structure having an internal perimeter and comprising top, bottom, left side and right side frame parts, in which each frame part comprises a respective generally planar inner surface, the inner surfaces of the frame parts together defining the internal perimeter; and a mount comprising an abutment surface configured to abut a surface of the window frame, in which the mount comprises a plurality of mount parts which together form the mount, a mount part being provided for each frame part, and in which: each mount part extends out of a plane defined by the generally planar inner surface of the respective frame part; and/or each mount part is upstanding from, or extends generally inwardly from, the generally planar inner surface of the respective frame part.

The generally planar inner surfaces may face inwardly, in use, towards the window aperture. The planes defined by the planar inner surfaces may each be disposed substantially parallel to a main axis of the window aperture (which axis may extend along the aperture from an external opening to an internal opening), and/or to a main axis of the main frame structure.

The mount/sealing component parts may each extend out of said planes in that at least part of the mount/sealing component part is disposed out of the plane. The mount parts may each define a part of the abutment surface. The sealing component parts may each define a part of the sealing surface. The frame parts may be arranged so that, in use, the main frame structure extends around a perimeter of the window aperture. Each frame part may define a respective part of the internal perimeter.

There is further disclosed a building comprising: a mounting frame or sealing frame as described above in which the mounting or sealing frame is permanently secured to the building.

Said mounting or sealing frame may be permanently secured to the building in that at least part of said frame may be hidden behind a finishing panel or panels (and/or a decorative surface finish) secured to the mounting frame, for example following positioning of the window frame within the window aperture. Securing may be achieved using one or more fixing (such as a mechanical fixing), and/or an adhesive, which may be hidden behind said panel or panels. Said mounting or sealing frame may remain secured to the building during a subsequent window replacement procedure, involving the location of a replacement window frame in the window aperture.

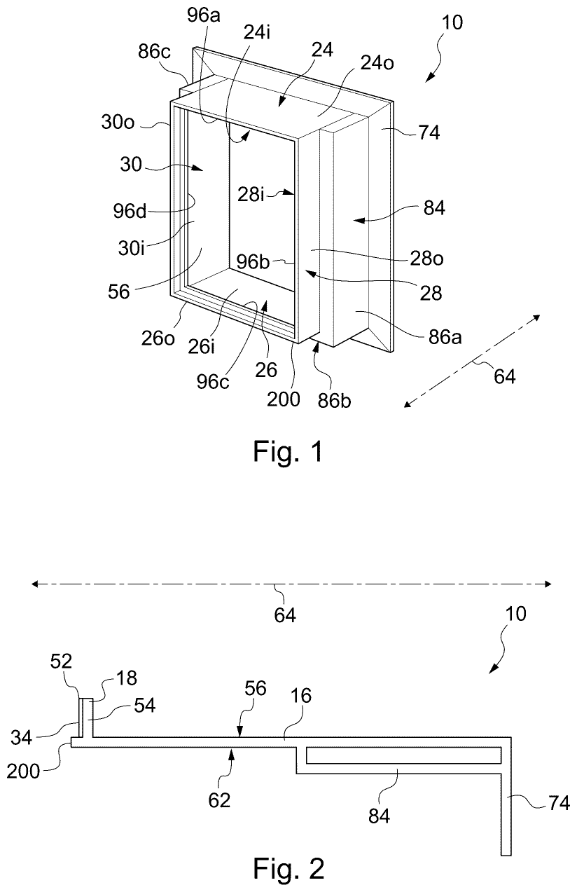

Turning now to FIG. 1, there is shown a perspective view of a mounting frame 10 according to an embodiment of the present invention. The mounting frame of this and each following figure is suitable for use with a closure such as a door or window in an aperture formed in any surface of a building (such as a wall or roofline) though the example of a window in a window aperture is given. The term building should be broadly interpreted to cover any structure that generally defines an interior and an exterior. The interior need not be fully enclosed: it may be open on one or more sides to the exterior. The building could be of any suitable type, and could for example be for domestic, commercial or industrial use. Suitable buildings could include houses, flats or apartments, hotels, office buildings and factories. In principle the mounting frame of the present invention may be used for mounting a closure in any wall or structure, for instance a freestanding wall. However, it will be appreciated that where a wall is freestanding—that is, exposed to the elements on both sides—then the need to render the closure air and water tight may be less compelling. In practical terms the mounting frame is primarily intended for fully enclosed buildings where weather tightness and thermal efficiency is a key concern.

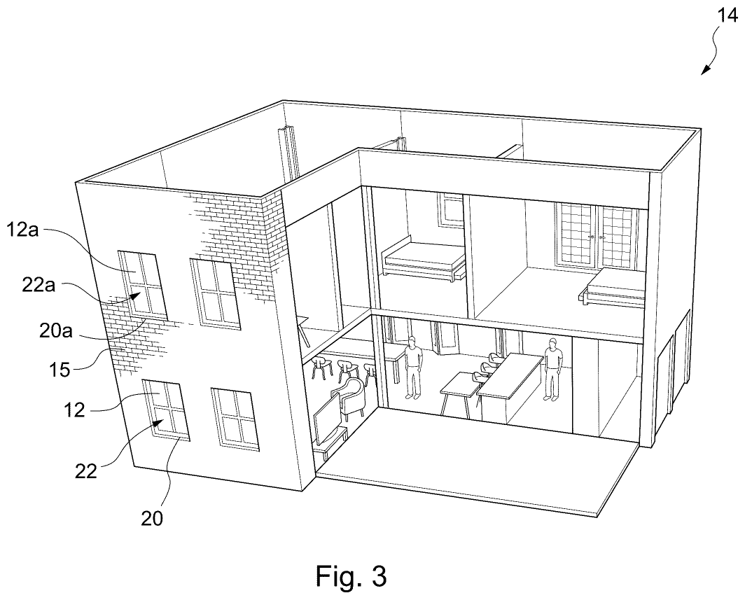

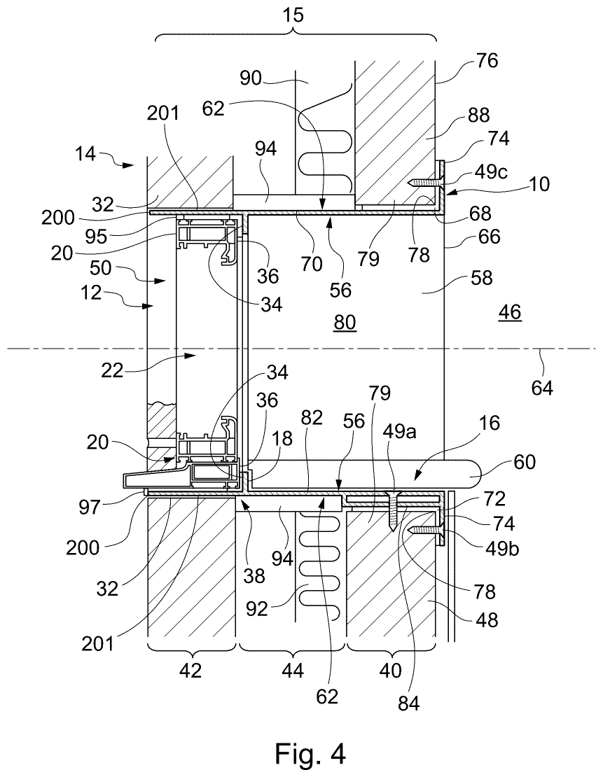

The mounting frame 10 is also shown in the cross-sectional side view of FIG. 2, which is drawn to a larger scale, and shown sectioned in a vertical plane, along a depth direction 64 of the mounting frame. Certain features of the mounting frame 10 are not shown in FIG. 2, for ease of illustration. In the illustrated embodiment, the mounting frame 10 has been used to install windows in a building 14, which takes the form of a detached house, as shown in the perspective view of FIG. 3. A roof and certain walls of the building 14 have been removed, for illustration purposes. FIG. 4 is also referred to, which is a cross-sectional side view of a wall 15 of the building shown in FIG. 3, drawn to a larger scale and sectioned in a vertical plane through one of the windows 22. The drawing shows the mounting frame 10 and the window 22 located in a window aperture 12 of the wall 15. In the illustrated embodiment, the window aperture 12 is provided in the wall 15, but it will be understood that the aperture may be provided in other structural parts of the building, including but not limited to its roof (not shown).

The mounting frame 10 generally comprises a main frame structure 16, and a mount 18 for a window frame 20 of the window 22 installed in the aperture 12. The main frame structure 16 is generally quadrilateral-shaped (square or rectangular) and comprises a top frame part 24, a bottom frame part 26, a left side frame part 28, and a right side frame part 30. The frame parts 24 to 30 are arranged so that the main frame structure 16 extends continuously around a perimeter of the window aperture 12, the perimeter indicated generally by numeral 32 in FIG. 4. The mount 18 extends generally in a direction away from the main frame structure 16 into the window aperture 12, and comprises an abutment surface 34 adapted to abut a surface 36 of the window frame 20, to define a mounting location (indicated at 38 in FIG. 4) for the window frame 20 within the window aperture 12. In the illustrated embodiment, the surface 36 is a rear-facing surface of the window frame 20, which facilitates an external mounting procedure of the window frame and so minimises disruption. However, the surface could be another surface of the window frame 20, suitably one which is generally in a plane of the window such as a front-facing surface.

In use, and as will be described in more detail below, the mount 18 facilitates insertion of the window frame 20 within the window aperture 12 at the correct final position for the window 22, that position being determined by factors including a depth dimension of the window frame, and a thickness of the wall 15 in which the window 22 is to be located. The wall thickness is dependent on the respective thicknesses of inner and outer wall skins 40 and 42 of the wall, as well as of a cavity 44 between the wall skins. Once located in the window aperture 12, the mounting frame 10 serves to restrict movement of the window frame 20 in an inward (or insertion) direction along the aperture towards an interior 46 of the building 14, and so effectively provides a fixed location for the window frame 20 (and so the window 22).

In FIGS. 1 and 2 the mounting frame 10, particularly the main frame structure 16 is shown in a first configuration in which the main frame structure 16 terminates at a tip 200 that does not extend significantly beyond the mount 18. However, in FIG. 4, while the mounting frame 10 is generally similar, a portion 201 of the main frame structure 16 extends further beyond the mount 18 before terminating at tip 200. Thus, in FIG. 4, the portion 201 of the main frame structure 16 extends fully or substantially around the window frame 20 (or may be set back from the outer edge of the window frame, for instance by 10 mm and the gap sealed after installation). As illustrated in FIG. 4 the extended portion 201 allows the main frame structure 16 to fully span inner and outer wall skins 40, 42 and the cavity 44. Accordingly the main frame structure 16, and indeed the mounting frame 10 as a whole serves as a cavity closer as well as securing and sealing to the building about the window aperture and sealing to the window frame. It will be appreciated that where the main frame structure 16 is foreshortened as illustrated in FIG. 2 then tip 200 may abut or only slightly span onto the outer wall skin 42. The lengthened form of the main frame structure 16 may be used in combination with the remaining features of the mounting frame 10 in any of the preceding or following embodiments of the invention. Additionally, as discussed in further detail below, the main frame structure 16 may be cut to length during installation.

An installation procedure for the window 22 involves firstly positioning the mounting frame 10 in the window aperture 12, and then securing the mounting frame to blockwork 48 of the wall 15 using mounting anchors (three shown and given the numerals 49a to 49c). The wall 15 will typically comprise cement blocks and/or bricks (not shown) forming the inner and outer wall skins 40 and 42. However, the building 14 may be of any suitable alternative construction, such as one comprising a timber frame structure defining the inner skin 40, and a blockwork (e.g. brick) structure forming the outer skin 42.

Once the mounting frame 10 has been positioned as shown in FIG. 4, the window frame 20 is inserted into an outer (or external) opening 50 of the aperture 12, and translated along the aperture until the rear-facing surface 36 of the window frame 20 contacts the abutment surface 34 of the mount 18. The window frame 20 is then in the mounting location 38, and can be secured to the wall 15 using mechanical fixings such as threaded anchors (not shown) which pass through the window frame, optionally through the extended portion 201 of the main frame structure 16 if present at the anchor location, and into blockwork of the outer wall skin 42. The window frame 20 is then in the correct, installation position, and a glazed unit or units (not shown) of the window 22 can be positioned within the window frame to complete the window. Of course, if desired the window frame 20 may be inserted with the glazed unit(s) already positioned, although that would increase its weight and make handling more challenging.

The mount 18, and in particular its abutment surface 34, acts to restrict further translation of the window frame 20 along the aperture 12 in a direction away from the outer opening 50. An operator installing the window frame 20 is therefore provided with a positive indication that the window frame is in the correct position when its rear-facing surface comes 36 into contact with the abutment surface 34 of the mount 18.

The window frame 20 can also be sealed relative to the mount 18 using a seal 52 (shown in FIG. 2 but not FIG. 4), which takes the form of a sealing strip of an elastomeric or rubber material applied to a core structure 54 of the mount, which takes the form of an elongate wall. The seal 52 defines at least part of the abutment surface 34 of the mount, and in the illustrated embodiment defines the entire abutment surface. In a variation, a sealing material such as a flowable time-setting silicone may be applied to the core structure 54 of the mount 18 and/or to the window frame 22, prior to bringing the frame and the mount into abutment. A further variation may employ a combination of a sealing strip and a flowable sealing material.

Arranging the abutment surface 34 of the mount 18 so that it abuts the rear-facing surface 36 of the window frame 20 may enable a compressive loading to be applied to the seal 52. This may be achieved by imparting a load on the window frame 20 during installation, causing the seal 52 to be compressed, and then anchoring the window frame to the outer wall skin 42 so that the compressive load is maintained. This may provide a much-improved seal bond in comparison to prior window systems, including those employing a cavity closer.

The mounting frame 10 can also be used in a building renovation procedure involving the removal of an existing window located in a window aperture, and the mounting of a replacement window in the aperture. For illustration purposes only, reference is made to a window 22a located in an aperture 12a in the building 14, which is to be replaced. A window frame 20a of the existing window 22a is firstly removed from the window aperture 12a. This may require that any external and/or internal sealant be removed or cut away, and that any mounting tape used to seal the window frame to the building (or tape and membrane if used) be severed. The mounting frame 10 can then be positioned in the window aperture 12, and the replacement window frame 20 inserted into the aperture and positioned in contact with the abutment surface 34 of the mount 18, following the procedure described above. In a similar fashion therefore, an installer is provided with a positive indication that the replacement frame 20 has been located in the correct position, when the rear-facing surface 36 of the replacement frame abuts the surface 34 of the mount 18.

As can be seen from the above, the present invention provides both an improved method of installing a window in a building, and an improved method of renovating a building by replacing a window, if for example a structure or visual appearance of the window degrades over time (such as due to UV light exposure).

Further structural details of the mounting frame 10 and associated methods will now be described.

The main frame structure 16 of the mounting frame 10 extends around the entire perimeter 32 of the window aperture. The main frame structure 16 therefore provides a secure mounting for the window frame 20 around its entire perimeter 32, and optionally also provides for sealing of the window frame around its entire perimeter by means of the seal 52.

The frame parts 24 to 30 forming the main frame structure 16 are provided as separate components which are coupled together to form the frame. This is typically achieved by cutting lengths of frame material to the sizes required to form the frame parts 24 to 30, and coupling the frame parts together. In a variation however, frame parts of appropriate lengths may be selected from a kit of parts having different lengths. As will be understood by the skilled person, suitable materials for the frame parts include extruded polymers such as un-plasticised polyvinylchloride (UPVC), which can easily be bonded or thermally welded together to form the frame structure 16. However, other materials including wood, metals/metal alloys and composite materials could be used. A mounting frame 10 of a desired shape and/or dimensions to suit the window aperture 12 can be easily formed by selecting frame parts of appropriate dimensions, and/or by cutting the frame parts to the required lengths.

In one embodiment the frame parts may be cut to size and bonded in a factory environment. In another embodiment a method of installing a window may comprise cutting frame parts from a continuous length of material, inserting the cut frame parts into a window aperture and bonding or thermally welding the cut frame parts together. The cut parts may comprise the main frame structure being integrally formed with one or more of the mount and the mounting flange. However, alternatively these may be separately cut parts that are also bonded or thermally welded together. The frame parts may be cut from a continuous length of extruded polymer mounting frame material. Thus a more flexible site-build method for constructing a mounting frame for a window frame is enabled.

In the illustrated embodiment of FIGS. 1, 2 and 4, the mount 18 is formed integrally with the main frame structure 16, for example in a manufacturing process for the frame material which is used to assemble the frame parts 24 to 30. The mount 18 and the main frame structure 16 are therefore of a unitary or one-piece construction. This can easily be achieved in the case of an extruded polymeric frame material.

The main frame structure 16 comprises an inner peripheral surface 56 which, in use, faces inwardly towards the window aperture 12. The inner peripheral surface 56 is defined by respective inner surfaces 24i to 30i of the frame parts 24 to 30 forming the main frame structure 16. The inner peripheral surface 56 opens on to the aperture 12, and the inner frame part surfaces 24i to 30i are substantially planar. The inner peripheral surface 56, or at least part of the inner peripheral surface, receives decorative finishing panels, two being shown in FIG. 4 in the form of a side panel 58 and a windowsill 60. These are secured to the mounting frame 10 following positioning of the window frame 20 at its mounting location 38. As is well-known, the finishing panels can be decorative, and/or can provide a surface to which a decorative coating (such as a cementitious plaster material) can be applied. The mounting frame 10 is effectively permanently secured to the building 14, in that it is at least partly hidden behind the decorative finishing panels 58 and 60 and/or any cementitious coating. The fixings 49a to 49c are similarly hidden. As will be understood, the mounting frame 10 can remain secured to the building 14 during a subsequent window replacement procedure, involving the location of a replacement window frame in the window aperture. As such a window replacement procedure comprises removing the original window frame and inserting the replacement window frame from the exterior of the building (that is, from the side opposite to the finishing panels) the finishing panels may remain undisturbed during the window replacement procedure.

As can clearly be seen in the drawings, the mount 18 extends out of or away from the inner peripheral surface 56 of the main frame structure 16, laterally into the window aperture 12. Each part of the mount 18 defined by the frame parts 24 to 30 extends generally out of the planes defined by the frame part surfaces 24i to 30i, and so are upstanding from the surfaces. The main frame structure 16 also comprises an outer peripheral surface 62 which, in use, faces away from the window aperture 12 towards the building structure surrounding and defining the window aperture (in this case the wall 15 structure). The outer peripheral surface 62 is defined by respective outer surfaces 240 to 300 of the frame parts 24 to 30 forming the main frame structure 16.

As best shown in FIG. 2, the abutment surface 34 of the mount 18 extends in a direction which is substantially perpendicular to the main frame structure 16. This provides an effective abutment for the window frame 20, and so secure positioning of the window frame in the aperture 12. It can also facilitate sealing of the window frame 20 to the mounting frame 10, by providing a location for the seal 52, which is compressed between the window frame and the core structure 54 of the mount as described above. The abutment surface 34 extends, in use, in a direction which is substantially perpendicular to a main axis 64 of the aperture 12, the axis extending along the aperture from the outer opening 50 to an internal opening 66. This axis 64 may be referred to as a window aperture depth axis. It will be understood here that the rear-facing surface 36 of the window frame 20 faces Inwardly, towards the interior 46 of the building 14. The abutment surface 34 (also referred to as a sealing surface 34) thus faces outwardly, towards the exterior of the building 14.

The seal 52 acts as a frame seal, for sealing the window frame 20 relative to the main frame structure 16. The frame seal 52 is typically bonded to the core structure 54 of the mount 18 using a suitable adhesive. However, the frame seal 52 may be provided integrally with the mount 18, or may be formed by the mount, for example in an over-moulding procedure, particularly where the mount is of a polymeric material.

The mounting frame 10 also comprises a building seal which abuts a surface of the building 14 such as its wall 15, for sealing the mounting frame relative to the building surface, and so the window frame 20 relative to the building surface once the window frame is positioned in the aperture 12. A number of such building seals are typically provided in order to ensure a good sealing effect, three such seals shown in FIG. 4 and indicated by numerals 68, 70 and 72. These seals are mounted on the main frame structure 16, and are typically elastomeric or rubber sealing strips that are bonded to the main frame structure using a suitable adhesive. Again however, the building seals 68 to 72 may be provided integrally with the main frame structure 16 or may be formed by the frame structure. For example, the seals 68 to 72 may be over-moulded on the main frame structure 16, particularly where it is of a polymeric material. Other options for one or more of the building seals exist, including beads of time-setting sealant material applied to the main frame structure, and/or to the building, prior to positioning of the mounting frame 10 in the window aperture 12. Suitable options for the sealant material include viscous silicone-based sealants.

The mounting frame 10 also comprises a mounting component 74 for locating the mounting frame on the building 14, such as on its wall 15. The mounting component 74 takes the form of a mounting flange which is provided integrally with the main frame structure 16, and which extends around its perimeter. In use, the mounting component 74 abuts an inner wall surface 76 of the wall 15, as shown in FIG. 4. The mounting frame 10, comprising the mounting component 74, overlaps an internal edge 78 of the wall 15 defined by the inner wall skin 40, at an intersection between the vertical inner wall surface 76 and a generally perpendicular surface 79 in a window reveal area 80. The mounting frame 10 passes over the edge 78 so that the mounting component 74 is disposed on the inner surface 76 of the wall.

As discussed above, the mount 18 defines a first sealing surface for sealing to the window frame. The mounting flange 74 defines a second sealing surface for sealing to the wall about the window aperture. The sealing may use seals already attached to one or both of the sealing surfaces or a sealant may be applied during installation. It will be apparent from inspection of the figures that the sealing surfaces face in the same direction. In particular, where the mounting frame is inserted from the inside of a building and the window aperture is inserted from the outside of the building, both sealing surfaces face to the exterior of the building. However, they are offset along the window depth axis.

The mounting frame 10, in particular its main frame structure 16, is generally L-shaped in cross-section, taken along the window aperture depth axis 64 (that is, in the depth direction of the frame), from front to back. The main frame structure 16 comprises a window reveal component 82 which resides within the window aperture 12 (in the reveal area 80), and the mounting component 74. Part of the L-shape is defined by the window reveal component 82 (forming part of the main frame structure 16) and part by the mounting component 74.

The mounting frame 10 may also comprises an insulation material, indicated generally by numeral 84, which covers part of the outer peripheral surface 62 of the main frame structure 16 (and optionally the entire surface or a substantial part of it). The insulation material 84 comprises a number of separate insulation components 86a to 86c, which are arranged around the outer perimeter of the main frame structure 16. Alternatively, the insulation material 84 may be integrally formed, for instance by an over-moulding process. The insulation components 86a to 86c are of a substantially rigid material such as a polymeric foam, and are mounted to frame parts 24 to 30 of the main frame structure 16. In the illustrated embodiment, the top frame part 24 is free from insulation material. It may not be necessary to provide insulation over the top frame part 24 as a lintel 88 forming part of the wall 15 (which in part defines the aperture 12) typically incorporates insulation material. Insulation material is also typically provided in the cavity 44, as indicated at 90, 92 and 94 in FIG. 4. Although not illustrated, in some embodiments insulation may be provided on internal or external portions of the main frame structure about all or part of its periphery. Where insulation is provided on part or all of the internal periphery of the main frame structure, finishing panels such as panels 58 and 60 described above may be provided over the insulation.

In a further alternative the insulation 84 may comprise an air gap formed by a pocket within the main frame structure 16 (that is, an integrally formed part of the main frame structure 16) such as through a continuous extrusion process. This is illustrated in FIGS. 2 and 4, whereas certain other figures show the insulation being separately formed or applied to the main frame structure 16. The air gap insulation 84 may be applied about part or the whole of the periphery of the main frame structure 16 and may extend over part or the whole of the depth of the main frame. The air gap or other form of insulation 84 forms a thermal break about the mounting frame to prevent thermal bridging through the mounting frame from the exterior to the interior of the building. Portions of the mounting frame may be formed from a polymeric material, which is itself insulative. The addition of air gaps or insulation such as an expanded foam applied to interior or exterior portions of the mounting frame increase the insulation of the mounting frame.

The mount 18 is typically formed integrally with the main frame structure 16, as described above. The illustrated mount 18 comprises a plurality of generally elongate protrusions in the form of lips or ribs 96 which together form the mount. Each frame part 24 to 30 comprises a respective such protrusion, and so the mount 18 comprises a top protrusion 96a, a bottom protrusion 96b, a left side protrusion 96c and a right side protrusion 96d. The elongate protrusions 92 each extend in a direction along a main length of the respective frame part 24, 26, 28 or 30 and the mount extends continuously (or substantially continuously) in a direction around the perimeter of the main frame structure 16.

The frame seal 52 and the building seals 68 to 72 together provide a primary barrier against cold air and moisture ingress along the window aperture 12 past the window frame 20, and warm air egress from the building interior 46. However, following positioning of the window frame 22 in the aperture 12 and securing of the frame, external seal beads 95 and 97 may be applied. These may provide a secondary barrier and/or a decorative finish. As is described below, the mounting frame provides multiple sealing surfaces (principally on the abutment or sealing surface of the mount and on the mounting flange) but also on other portions of the main frame structure that serve to seal about the mounting frame to prevent the ingress of rain water or to prevent water ingress through capillary action.

FIG. 4 shows an example installation in which the mounting frame 10 is installed in a window aperture 12 formed in a wall 15 having interior and exterior wall skins 40 42 formed from brick or blockwork and a cavity 44 therebetween. However, the present invention is not limited to this. For instance, in an alternative, not illustrated, the wall 15 may be constructed using Structural Insulated Panels (SIPs). A SIP comprises an insulating foam core sandwiched between two structural facings. The facings may be wooden, for instance Oriented Strand Board (OSB). Commonly a SIP panel wall is covered with a waterproof and/or airtight membrane which may be pre-applied or applied on-site. According to the present invention a window aperture may be formed in a SIP wall and a mounting frame as described above inserted into the aperture and secured on the inside of the building with the mounting frame flange attaching to the surrounding wall surface. It may be secured in place and sealed as described above. Then the SIP membrane may be secured to the outer periphery of the mounting frame for instance by being glued to the outer side of the main frame structure. This process may be aided by cutting the membrane such that it extends into the window aperture allowing it to be splayed outwards onto the mounting frame and glued. Cladding material may then be applied over the SIP wall about the window aperture. The main frame structure may be dimensioned so that it extends partially or fully through the cladding (and may help support or locate the cladding). The window may then be offered up to and secured to the mounting frame.

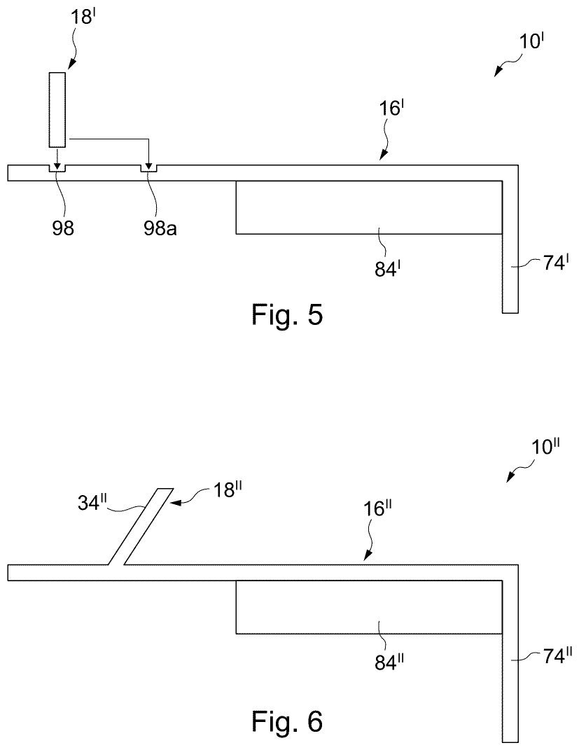

A mounting frame according to an alternative embodiment of the invention is shown in FIG. 5, which is a cross-sectional side view similar to that of FIG. 2, the mounting frame indicated generally by reference numeral 101. Like components with the mounting frame 10 of FIG. 1 share the same reference numerals, with the addition of the suffix^{I}. Only substantial differences will be described here.

In this embodiment, a mount 18^{I} of the mounting frame 10^{I} is provided separately from its main frame structure 16^{I}, and is coupled to the main frame structure as shown in the drawing. The mount 18^{I} can be bonded to the main frame structure 16^{I}, or secured with a mechanical fixing. In the illustrated embodiment, the main frame structure 16^{I} comprises a coupling feature 98, in the form of an elongate channel or slot, which receives the mount 18^{I} for coupling it to the main frame structure 16^{I}. The channel 98 is dimensioned to receive the mount 18^{I} in a push or sliding-fit, and may provide an interference fit with the mount to retain the mount once it has been inserted. However, an adhesive may additionally or alternatively be used to secure the mount 18^{I}, if desired.

A plurality of such coupling features 98 may be provided, spaced apart along the main frame structure 16^{I}, for example along its depth dimension. This is also shown in FIG. 5, the main frame structure 16^{I} comprising first and second spaced coupling features 98 and 98a, which provide separate mounting locations for the mount 18^{I}, and so for the window frame 20. Whilst two such mounting features 98 and 98a are shown, more than two may be provided depending upon factors such as a depth of the window frame 20. Advantageously therefore, the mounting frame 10^{I} is capable of providing more than one possible mounting location for the mount 18^{I}, which may facilitate use of the mounting frame with window frames 20 of different types (for example, having different dimensions such as frame depth), and/or may provide for a degree of adjustment to the position of the window frame in the aperture during installation. The mount 18^{I} may be formed from a plurality of mount parts, one for each frame part of the main frame structure, the mount parts together forming the assembled mount. This may facilitate location of the mount 18^{I} in a selected one of the coupling features 98 and 98a according to the circumstances.

A mounting frame according to another alternative embodiment of the invention is shown in FIG. 6, which is a cross-sectional side view similar to that of FIG. 2, the mounting frame indicated generally by reference numeral 10^{II}. Like components with the mounting frame 10 of FIG. 1 share the same reference numerals, with the addition of the suffix^{II}. Only substantial differences will be described here.

In this embodiment, the mounting frame 10^{II} again comprises a main frame structure 16^{II} and a mount 18^{II}. As shown in the drawing, the mount 18^{II} has an abutment surface 34^{II} which is inclined, and so at a non-parallel angle relative to a line that is perpendicular to the main frame structure, and/or relative to the main axis 64 of the window aperture 12. The angle of inclination which is selected may be dependent upon a shape or profile of the rear-facing surface of the window frame 20, for example if the window frame includes a bevelled or inclined portion adjacent its outer perimeter. Other angles of the surface, and indeed shapes of the mount, may be provided depending on factors including the shape of the window frame. Further, where the mount 18 is provided by a separable component as in FIG. 5, and particularly where a kit of parts of different mounts are provided, then the mounts may vary for instance in terms of angle or shape.

A mounting frame according to a further alternative embodiment of the invention is shown in FIG. 7, which is a cross-sectional side view similar to that of FIG. 2, the mounting frame indicated generally by reference numeral 10^{III}. Like components with the mounting frame 10 of FIG. 1 share the same reference numerals, with the addition of the suffix^{III}. Only substantial differences will be described here.

The mounting frame 10^{III} again includes a main frame structure 16^{III} and a mount 18^{III}. In this embodiment however, the mounting frame 10^{III} is adjustable, in this case at least one dimension of the mounting frame being adjustable. The dimension of the mounting frame 10^{III} which can be adjusted is a depth of the frame, considered in a direction along the main axis 64 of the window aperture 12. This facilitates adjustment of the mounting frame 10^{III}, for instance to suit building walls having different depths, and may provide for adjustment to account for variations in building practices such as cavity 44 depths between inner 40 and outer 42 wall skins.

The illustrated mounting frame structure 16^{III} comprises a first frame component 100 and a second frame component 102 which are coupled together to form the main frame structure. The first frame component 100 is mounted for movement relative to the second frame component 102, which facilitates the adjustment. The first frame component 100 is an inner frame component which defines the mount 18^{III}, and the second frame component 102 is an outer frame component. This may however be reversed. The inner frame component 100 is mounted for sliding movement within and relative to the outer frame component 102, and is suitably arranged so that it is telescopically mounted within the outer frame component. In this way, the inner frame component 100 can slide in a front to back direction relative to the outer frame component 102, to adjust a depth dimension D of the mounting frame 10^{III}.

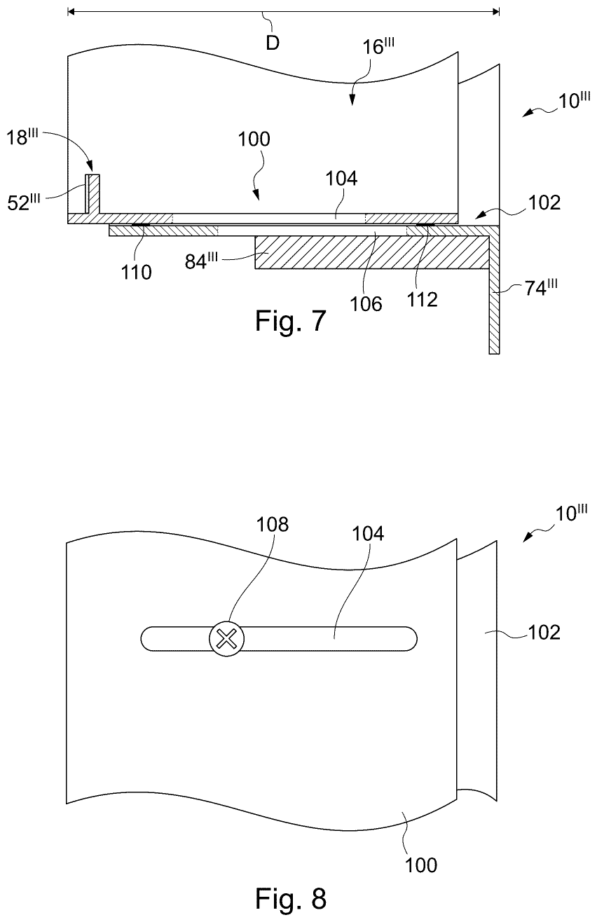

The telescopic movement could be achieved in a number of ways. In its simplest form, the inner frame component 100 may be dimensioned to be a relatively loose fit within the outer frame component 102, so that the position of the inner component relative to the outer component can easily be adjusted. One other possibility is shown in FIG. 7, as well as in the plan view of FIG. 8, which is a cross-sectional plan view of the mounting frame sectioned in a horizontal plane, across its width dimension. In this case, the inner 100 and outer 102 frame components comprise respective elongate slots or channels 104 and 106, each having closed ends. The slots 104 and 106 are positioned such that they can be aligned when the inner frame component 100 is positioned within the outer frame component 102. A fixing element such as a threaded screw 108 can then be passed through the aligned slots to couple the frame components 100 and 102 together. The threaded screw also typically serves for securing the mounting frame 100^{III} within the window aperture 12, such as to the blockwork 88. When tightened, the screw 108 clamps the frame components 100 and 102 together to restrict further relative movement. A plurality of such aligned slots 104/106 will typically be provided, for example one or more on each frame part of the main frame structure 16^{III}, or pairs of aligned slots on two or more opposed frame parts (e.g. top and bottom, left side and right side). Fine adjustment of the mounting frame depth can be achieved during installation, if required, simply by backing out the screw 108 a small distance.

In order to maintain a seal and so restrict air and moisture bypassing around the mounting frame 10^{III} during use, a seal 52^{III} is again provided on the mount 18^{III}, and one or more seals 110 and 112 are provided between the inner and outer frame components 100 and 102. The seals 110 and/or 112 provide a sliding seal between the inner and outer frame components 100 and 102 allowing for the sliding movement. Elastomeric or rubber materials may be used for the seals 110 and 112, although other materials may be better suited to providing a sliding seal without overly restricting relative movements between the frame components, including low friction polymeric materials such as PTFE.

It will be understood that the inner and outer frame components 100 and 102 can each be constructed following the same principles as the main frame structure 16 of the mounting frame 10 shown in FIG. 1. Thus the inner and outer frame components may comprise respective frame parts which make up the assembled component, with top, bottom, left side and right side frame parts.

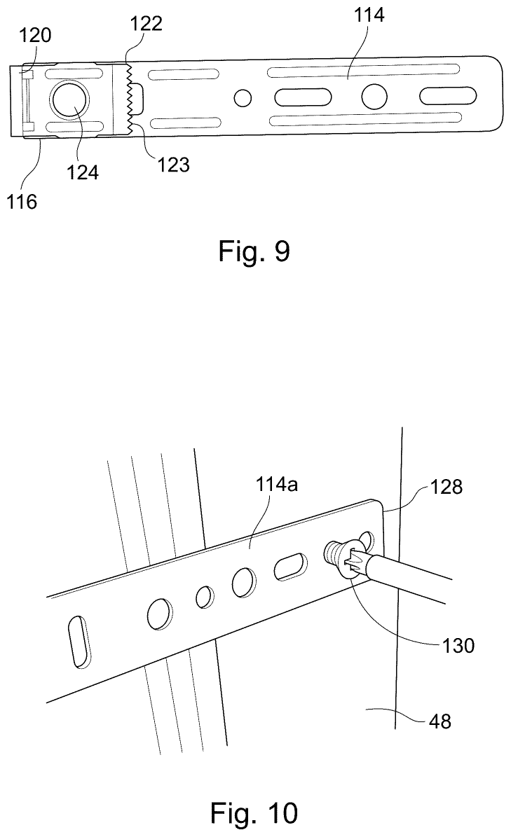

As is known generally in the industry, the window frame 20 can be mounted within the window aperture 12 using one or more elongate mounting bracket. One such known mounting bracket is shown in FIG. 9, and given the reference numeral 114. The mounting bracket 114 is secured to the window frame 20 towards a first end 116, suitably via a spring-type clip arrangement having first and second opposed clips 120 and 122. The clips 120 and 122 are typically received in a channel (not shown) extending around an exterior perimeter of the window frame 20, the channel being bound by side wall surfaces provided on or in the exterior perimeter of the frame. The clips 120 and 122 typically engage in the channel in a snap or twist-fit, to connect the bracket 114 to the window frame 20. For example, the clip 122 can carry teeth 123 which can engage one of the side wall surfaces of the channel, and the clip 120 can then be push fitted into the channel, deflecting so as pass into the channel, where it abuts the other channel side wall. A twist-fit would involve aligning the bracket 114 with the channel so that the clips 120 and 122 are both positioned within it, and then rotating the bracket through 90 degrees so that the clips engage the channel side walls. It will be understood however that the bracket 114 could additionally or alternatively be secured to the window frame 20 using a mechanical fixing (not shown) such as a screw passing through an eye or aperture 124 of the bracket and into the window frame.

FIG. 10 shows an alternative bracket 114a of similar construction, which has been secured to a window frame as discussed above. The bracket 114a passes away from the window frame along the window aperture 12, in a direction towards the interior of the building 14. The bracket 114a is secured to the blockwork 48 of the building 10 towards a second end 128 using a mechanical fixing such as a screw 130. The window frame 20 is then securely positioned within the window aperture 12, secured to the blockwork 48.

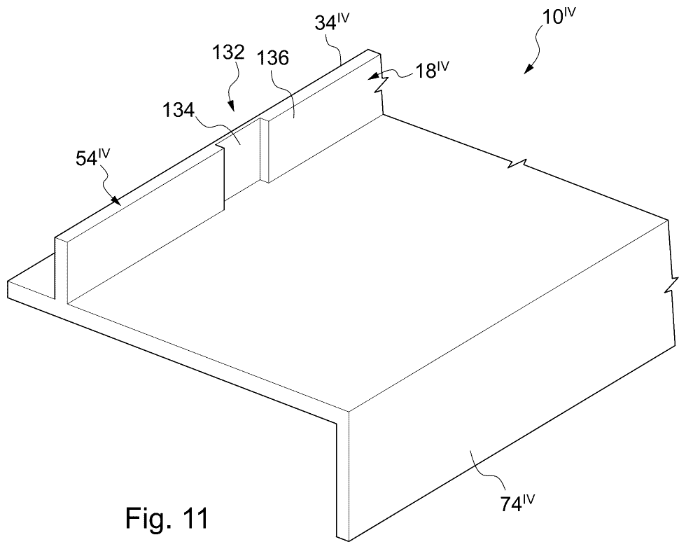

The mounting frames 10 to 10^{III} of the invention may be able to accommodate mounting brackets of this type if desired or required to secure the window 12 in place. Where a mounting bracket or brackets are to be used, the brackets have to pass through the mount 18 in order to extend along the window aperture 12 to a position at which it can be secured to the blockwork 48. To this end, and referring to FIG. 11, there is shown a cutaway perspective view of a mounting frame 10^{IV} in accordance with a still further embodiment of the present invention. The mounting frame 10^{IV} is of similar construction to the mounting frame 10 shown in FIG. 1, and like components share the same reference numerals with the addition of the suffix^{IV}.

In this embodiment, a mount 18^{IV} of the mounting frame 10^{IV} comprises one or more access zones or areas 132 for the bracket 114, so that the bracket can pass from the window frame 20 through or past the mount, for connection to the blockwork 48 as described above. In the illustrated embodiment, the access zone 132 is defined by a removable wall portion 134 of a core structure 54^{IV} of the mount 18^{IV}. The removable wall portion 134 has a reduced depth relative to a remainder or main portion 136 of the mount 18^{IV}. The removable wall portion defines part an abutment surface 34^{IV} of the mount 18^{IV}, so that a continuous abutment surface can be defined in situations where the mounting bracket 114 is not required. If however the mounting bracket 114 is to be used, then the wall portion 134 can be removed (e.g. punched, cut, twisted or snapped out) to define a passage or pathway for the bracket. This may be achieved by making the depth of the wall portion 134 sufficiently small to facilitate its ready removal, and/or by making the wall portion frangible. In the latter case, this may involve introducing a line or lines of weakness at or near a perimeter of the wall portion 134, so that its connection with the remainder 136 of the mount 18^{IV} can easily be broken.

Preserving a substantially air (and moisture) tight seal with the window frame 20 would require the application of a sealing component or material to the aperture in the mount 18^{IV} which is created when the wall portion 134 is removed. Suitable options could be a flowable sealant such as a silicone based sealant, which would seal over the bracket 114 and block the aperture.

In a variation on the illustrated embodiment, one or more simple aperture may be provided in the mount 18^{IV}, through which the bracket 114 can pass. If brackets are not required then the aperture can be closed using a suitable blocking or sealing component (e.g. of an elastomeric material), and/or by applying a flowable sealing material to the aperture.

It will be understood that the above applies also to the mounting frames 10^{I} to 10^{III}, in situations where one or more mounting bracket is to be used to secure the window frame.

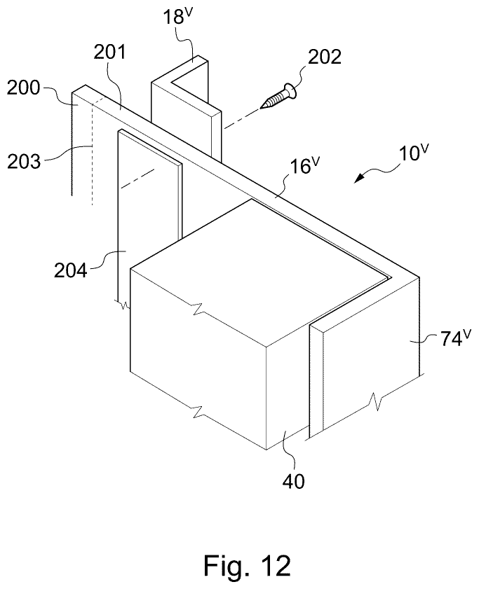

Turning now to FIG. 12, this illustrates a mounting frame 10^{V} according to a further embodiment of the present invention. FIG. 12 is a perspective cross-sectional view of the mounting frame 10^{V} which is generally similar to that of FIG. 2. Like components with the mounting frame 10 of FIG. 1 share the same reference numerals, with the addition of the suffix^{V}. Only substantial differences will be described here. The mounting frame 10^{V} is shown without any attached insulation 84, though it will be understood that this may be provided. In this embodiment the main frame structure 16^{V} is shown resting upon the inner wall skin 40 with mounting flange 74^{V} shown overlapping the wall skin 40. In this example the mount 18^{V} is provided as a separate component and the main frame structure 16^{V} is shown having an extended portion 201 terminating in tip 200 as in FIG. 4.

Mount 18^{V} is an elongate L-shaped piece configured to be attached to the main frame structure 16^{V} at a freely selected location and secured using screws 202, for instance self-tapping screws configured to secure extruded polymer parts together. Advantageously, this permits the mounting location of the window frame to be freely selected within the window aperture 12. The location of the mounting frame 10^{V} within the window aperture 12 is determined by the mounting flange 74^{V} coming to rest against the inner wall skin 40. The required mounting location may be freely selected. Optionally, the main frame structure 16^{V} may be cut down to size according to the selected location of the mount 18^{V}, for instance along the dotted line 203. The skilled person will appreciate that this option for the main frame structure to extend significantly beyond the mount and to be cut to size during installation is generally applicable to all of the mounting frames described in this document. Cutting of the main frame structure may be facilitated by one or more score marks or weakened portions being formed within the main frame structure on the exterior side of the mount such that the main frame structure is friable and can be snapped off along the score mark or weakened portion.

If required, on the reverse side of the main frame structure 16^{V} a metal plate 204 may be provided such that the screws 202 pass through to the metal plate 204. The metal plate 204 thus provides reinforcement to the main frame structure. It also serves to secured fix the screws 202. The metal plate 204 may be blank such that a self-tapping screw can engage it at any location. Alternatively, a series of partial or full depth holes may be provided to receive screws, which may align to screw holes preformed in the mount. It will be understood that particularly where self-tapping screws are used the installer may select an appropriate number of screws according to the length of the mount.

While reference is made to the use of screws to secure the mount 18^{V} to the main frame structure 16^{V}, it will be understood that this is only one option. Alternative fixing devices such as nuts and bolts or adhesives may be used to secure the mount 18^{V} at the selected location. Where both the main frame structure and the mount are formed from a polymer material then they may be bonded or thermally welded together to secure the mount. Further attachment options will be apparent to the skilled person.

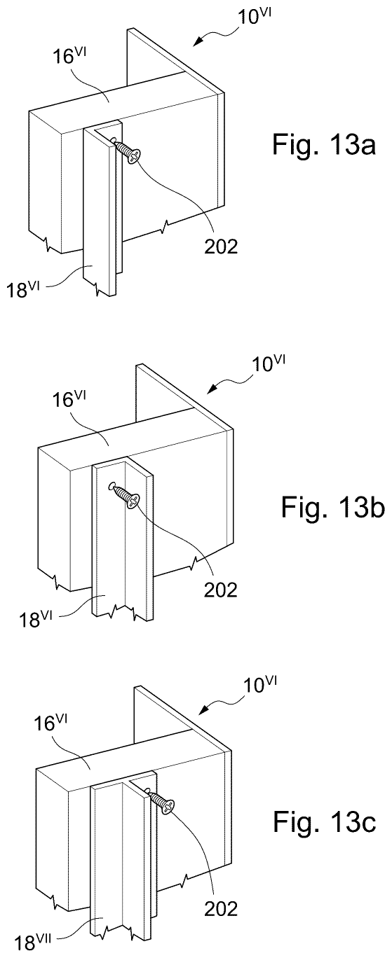

FIG. 13a illustrates a further mounting frame 10^{VI} which is generally similar to FIG. 12 but viewed from an alternative perspective. Mount 18^{VI} is generally the same as mount 18^{V}. Main frame structure 16^{VI} differs from main frame structure 16^{V} in that is comprises a thickened portion to which the mount is attached which comprises both an insulating and a structural purpose. No metal plate is shown in FIG. 13a (or also FIGS. 13b and 13c described below) though it will be understood that one may be provided if required for reinforcement or to securely receive screws. The thickened main frame structure 16^{V} may in some embodiments suffice to secure the screws by being formed of a sufficiently dense material to engage the full depth of the screw, while also providing an insulative function.

FIG. 13b is generally the same as FIG. 13a except that the mount 18^{VI} is shown reversed: that is, the L-shaped portion faces the opposite direction. In this embodiment the window frame will seat on top of the portion of the mount 18^{VI} which is secured with screws to the main frame structure 16^{VI}.

FIG. 13c is generally the same as FIG. 13a except that the mount 18^{VII} is T-shaped instead of L-shaped. Screws 202 may be passed through the flat parts facing the main frame structure 16^{VI} on either side of the upstanding part.

The skilled person will appreciate that further variants of the mounts shown in FIGS. 12 and 13a to c are possible provided that they include at least a portion adapted for securing to the main frame structure (and which may not necessarily extend along the entire length of the mount) and at least an upstanding portion to define the abutment or sealing surface for the window frame.

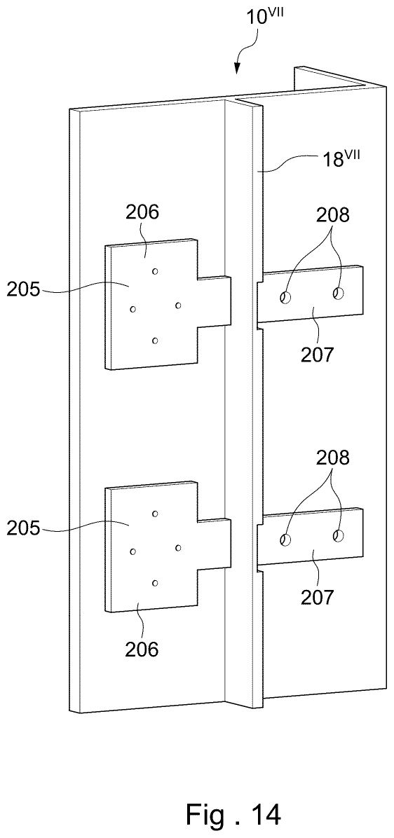

Turning now to FIG. 14, this illustrates an alternative to the mounting bracket 114 of FIGS. 9 and 10. In FIGS. 9 and 10 the mounting bracket 114 is previously attached to the window frame such that when the window frame is inserted into the window aperture and offered up to the mounting frame the bracket 114 extends through the mount 18 by removing a removable wall portion 134 (illustrated in FIG. 11) before fixings are passed through bracket 114 to secure the window frame (and also the mounting frame) to the wall. In FIG. 14 each bracket 205 instead forms part of the mounting frame 10^{VII}. Each bracket comprises a first portion 206 that sits on the side of mount 18^{VII} on which the window frame will be provided. The bracket 205 may comprise a metal plate such that a screw may be passed through the window frame to engage the first portion 206 of the bracket 205 to secure the window frame to the mounting frame 10^{VII}. A second portion 207 passes through the mount 18^{VII} and screws may be passed through holes 208 to secure the bracket (implicitly also the remainder of the mounting frame 10^{VII}) and the window frame to the wall.

Advantageously, the bracket 205 allows the window frame to be firmly secured even if its location along the window aperture depth axis is positioned adjacent to a cavity. Conventionally, when windows are installed, they must be positioned within the window aperture so that the window frame is aligned with blockwork and does not sit over the cavity such that screws passed through the window frame engage the blockwork.

Essentially the bracket 205 transfers the fixing load for the window frame along the depth axis of the window aperture to a location in which the load may be transferred directly to an inner wall skin comprising brick or blockwork. This gives the window installer complete freedom to install the window frame at any depth position within the window aperture, selected for aesthetic reasons, this choice not being constrained by the construction of the wall. It will be understood that this freedom is further enabled by the various embodiments of the invention described above in which the location of the mount is adjustable along the depth axis. As illustrated in FIG. 14 the first portions 206 of the brackets are shown enlarged such that they may receive fixing screws from the window frame at any locations. Holes may be predrilled as illustrated in the first portions 20 or self-tapping screws may be used. In FIG. 14 the mount 18^{VII} is not specifically shown as moveable though it will be understood that the bracket 205 of FIG. 14 may be provided with the mount of any preceding embodiment by providing a clearance slot within the mount. It will be understood that where previous embodiments are described as having mounts that are adjustable in position this also enables a free choice for the installer to position the window at any position along the window depth axis even if the conventional brackets 114 of FIGS. 9 and 10 are used in place of the brackets 205 of FIG. 14.

Where the mounting frame is inserted into a window aperture in a wall formed other than the use of brick or blockwork, for instance in a SIP wall as discussed previously, it may be that the bracket 205 together with the main frame structure 15 and any structural or insulative material backed onto the main frame structure may provide the necessary structural rigidity to support a window frame without the necessity of fixings to pass fully through the second portion 207 into the structure of the wall.

The present invention has been described in the context of a mounting frame serving for mounting a window within a window aperture in a wall of a building. As will be understood from the foregoing description however, the mounting frame as described also provides for sealing of a window frame within such a window aperture. The description therefore applies equally to a sealing frame for sealing a window frame within such an aperture, as defined in the consistory clauses and/or accompanying claims. In addition, whilst aspects of mounting and sealing frames are described, the invention encompasses a frame for mounting a window within a window aperture in a building and for sealing the window. The invention also encompasses a two-piece window assembly comprising a window frame of the type shown in the drawings, and a mounting frame, sealing frame, or mounting and sealing frame of the type described above.

The invention further encompasses a method of installing a window within a window aperture of a building, and a method of renovating a building involving the replacement of a window installed within a window aperture of the building. Features of such methods can readily be understood from the foregoing description.

Various modifications may be made to the foregoing without departing from the spirit or scope of the present invention.

For example, in a further variation, a mounting frame may be provided which comprises a plurality of different mounts. A kit comprising two or more different mounts may be provided. At least one parameter of a first mount of the kit may differ from the corresponding parameter of a further one or more mount of the kit. A selected parameter may be a height of the mounts, which may determine the extent to which the mounts extend from the main frame structure into the window aperture. A selected parameter may be an angle of the abutment surface defined by the mount, considered relative to the main frame structure and/or to a main axis of the window aperture. A selected parameter may be a profile of the mount e.g. in cross-section.

The main frame structures of the embodiments shown in the drawings are generally quadrilateral in shape, but could be other shapes including generally circular, oval, oblong, and triangular, the shape defined by the window aperture. It will be understood that main frame structures having such different shapes may not necessarily have the top, bottom, left side and right side frame parts shown in the drawings. However, the principles of the invention apply equally to such structures in terms of the way in which the mount/sealing component extends from the main frame structure to abut/seal against a window frame surface.

In some aspects and/or embodiments of the invention, reference is made to an abutment surface or a sealing surface which is adapted to abut a rear-facing surface of a window frame. It will be understood however that the abutment may be with a surface other than the rear-facing surface of the window frame, and may for example be with a front or outward-facing surface. Abutment with a rear-facing surface may however be preferred as this enables external fitting of the window frame, which may reduce disruption to internal building structures, particularly during window replacement.

Further aspects and/or embodiments of the invention may combine the features of one or more aspect and/or embodiment disclosed in this document. Accordingly, such further aspects and/or embodiments may comprise one or more feature selected from one or more aspect or embodiment of the invention disclosed in this document.

Unless explicitly implied by context or stated in the document, the features of any method or process disclosed in this document need not necessarily be performed in the precise order set out in the relevant text and/or drawings. Accordingly, any method or process disclosed in this document may be capable of being performed in an order other than that specifically set out in the relevant text/drawings, if circumstances permit.

Features disclosed in this document (including any accompanying claims, abstract and drawings) may be replaced by alternative features serving the same, equivalent or similar purpose, unless expressly stated otherwise. Accordingly, features disclosed in this document may represent only one example of a generic series of equivalent or similar features.

Reference is made in this document to features as being in ‘top’, ‘bottom’, ‘left’ or ‘left side’ and ‘right’ or ‘right side’ orientations, with particular reference to frame parts of the main frame structure. It will be understood that these apply generally to a typical location of a window in a wall of a building, in a generally vertical plane, or optionally in a plane which is angled relative to the vertical (e.g. inclined, or potentially horizontal in the case of a window installed in a flat-roof type structure). References to such features should not therefore be taken to imply a particular orientation of the window during use, and so are not to be taken as limiting on an orientation of the mounting/sealing frame of the invention.

Throughout this specification, the words “comprise” and “contain” and variations of them mean “including but not limited to”, and they are not intended to (and do not) exclude other components, integers or steps. Throughout this specification, the singular encompasses the plural unless the context otherwise requires. In particular, where the indefinite article is used, the specification is to be understood as contemplating plurality as well as singularity, unless the context requires otherwise. Throughout this specification, the term “about” is used to provide flexibility to a range endpoint by providing that a given value may be “a little above” or “a little below” the endpoint. The degree of flexibility of this term can be dictated by the particular variable and can be determined based on experience and the associated description herein.

Features, integers or characteristics described in conjunction with a particular aspect or example of the invention are to be understood to be applicable to any other aspect or example described herein unless incompatible therewith. All of the features disclosed in this specification, and/or all of the steps of any method or process so disclosed, may be combined in any combination, except combinations where at least some of such features and/or steps are mutually exclusive. The invention is not restricted to the details of any foregoing examples. The invention extends to any novel feature or combination of features disclosed in this specification. It will be also be appreciated that, throughout this specification, language in the general form of “X for Y” (where Y is some action, activity or step and X is some means for carrying out that action, activity or step) encompasses means X adapted or arranged specifically, but not exclusively, to do Y.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The reader's attention is directed to all papers and documents which are filed concurrently with or previous to this specification in connection with this application and which are open to public inspection with this specification, and the contents of all such papers and documents are incorporated herein by reference.

1. A sealing frame for sealing a closure within an aperture in a building, the sealing frame comprising:
a main frame structure arranged so that, in use, the main frame structure extends around a perimeter of the building aperture;
a sealing component for a closure frame of the closure, the sealing component extending, in use, away from the main frame structure and into the building aperture and comprising a first sealing surface facing in a first direction along a depth axis of the building aperture and which is adapted to abut a surface of the closure frame, for sealing the closure frame relative to the main frame structure and so the closure relative to the building; and
a mounting flange adapted to abut a building surface for locating the sealing frame in the building aperture, the mounting flange defining a second sealing surface facing in the first direction along the depth axis of the building aperture;
wherein the first and second sealing surfaces are offset from one another along the depth axis of the building aperture.

2. A sealing frame according to claim 1, wherein the first sealing surface is adapted to abut a rear-facing surface of the closure frame.

3. A sealing frame according to claim 1, further comprising:
a frame seal for sealing the closure frame relative to the sealing frame;
wherein the frame seal is mounted on the sealing component and bonded to it; or
wherein the frame seal is provided integrally with the sealing component.

4. A sealing frame according to claim 1, in which the second sealing surface is adapted to abut a surface of a building structure surrounding the building aperture;
wherein the mounting flange defines an abutment surface adapted to abut a surface of the building structure; and
wherein the sealing frame is adapted to overlap an internal edge of the closure aperture defined between the surface of the building structure and a generally perpendicular surface in a reveal area of the building aperture;
optionally wherein the sealing frame further comprises:
a building seal for sealing the mounting flange to a surface of a building structure surrounding the building aperture;
wherein the building seal is mounted on the mounting flange and bonded to it; or
wherein the building seal is provided integrally with the mounting flange.

5. (canceled)

6. A sealing frame for sealing a closure within an aperture in a building, the sealing frame comprising:
a main frame structure arranged so that, in use, the main frame structure extends around a perimeter of the building aperture; and
a sealing component for a closure frame of the closure, the sealing component extending, in use, away from the main frame structure and into the building aperture and comprising a first sealing surface which is adapted to abut a surface of the closure frame, for sealing the closure frame relative to the main frame structure and so the closure relative to the building;
wherein the sealing frame further comprises a mounting flange adapted to abut a building surface for locating the sealing frame in the building aperture and defining a second sealing surface, the mounting flange having a building seal provided on the second sealing surface for sealing the sealing frame relative to the building; or
wherein the sealing frame further comprises a frame seal for sealing the closure frame relative to the sealing frame, the frame seal being provided on the first sealing surface.

7. A sealing frame according to claim 6, wherein the first sealing surface is adapted to abut a rear-facing surface of the closure frame; and
wherein the frame seal is mounted on the sealing component and bonded to it or the frame seal is provided integrally with the sealing component.

8. A sealing frame according to claim 6, wherein the second sealing surface is adapted to abut a surface of a building structure surrounding the building aperture;
wherein the mounting flange defines an abutment surface adapted to abut a surface of the building structure; and
wherein the sealing frame is adapted to overlap an internal edge of the closure aperture defined between the surface of the building structure and a generally perpendicular surface in a reveal area of the building aperture.

9. A sealing frame according to claim 6, wherein the building seal is mounted on the mounting flange and bonded to it; or
wherein the building seal is provided integrally with the mounting flange.

10. A sealing frame for sealing a closure within an aperture in a building, the sealing frame comprising:
a main frame structure arranged so that, in use, the main frame structure extends around a perimeter of the building aperture and defines a first portion extending along a depth axis of the building aperture in which the sealing frame is to be installed; and
a sealing component for a closure frame of the closure, the sealing component extending, in use, away from the first portion of the main frame structure and into the building aperture, and comprising a first sealing surface adapted to abut a surface of the closure frame, for sealing the closure frame relative to the main frame structure and so the closure relative to the building;
wherein the first portion of the main frame structure is configured to close a cavity formed between inner and outer building layers; and
wherein the main frame structure defines a second sealing surface which is adapted to abut a building surface for sealing the sealing frame to the building around the perimeter of the building aperture.

11. A sealing frame according to claim 10, wherein the cavity comprises an insulating cavity between inner and outer building layers, and optionally the cavity is at least partially filled with an insulating material.

12. A sealing frame according to claim 10, wherein the first sealing surface is adapted to abut a surface of the closure frame on a first side of the sealing component and an internal surface of the first portion of the main frame structure on a second side of the sealing component comprises a closure reveal component arranged in use to be positioned within the building aperture;
wherein the closure reveal component is configured to receive a finishing material, finishing panel or finishing strip.

13. A sealing frame according to claim 10, wherein the main frame structure comprises a mounting flange adapted to abut a building surface for locating the sealing frame in the building aperture; and
wherein the mounting flange defines the sealing surface and a building seal is provided on the mounting flange for sealing the sealing frame relative to the building:
optionally wherein:
the building seal is mounted on the mounting flange and bonded to it; or
the building seal is provided integrally with the mounting flange.

14. (canceled)

15. A sealing frame according to claim 10, wherein the sealing surface comprises a second sealing surface; and
wherein the sealing component comprises a first sealing surface for sealing the closure frame relative to the main frame structure and so the closure relative to the building:
optionally wherein:
the first and second sealing surfaces face in a first direction along a depth axis of the building aperture and are offset from one another along the depth axis of the building aperture; and
the first sealing surface is adapted to abut a rear-facing surface of the closure frame.

16. (canceled)

17. A sealing frame according to claim 10, further comprising:
a frame seal for sealing the closure frame relative to the sealing frame;
wherein the frame seal is mounted on the sealing component and bonded to it; or
wherein the frame seal is provided integrally with the sealing component.

18. A two-piece closure assembly comprising:
closure frame; and
a sealing frame according to claim 1.

19. (canceled)

20. A method of installing a closure within an aperture of a building, the method comprising the steps of:
positioning a sealing frame according to claim 1 within the building aperture;
inserting a closure frame into an opening of the building aperture;
translating the closure frame along a depth axis of the building aperture in a direction away from the opening to a mounting location at which a surface of the closure frame contacts an abutment surface defined by the sealing component; and
securing the closure frame to the building at the mounting location.

21. A method of renovating a building involving the replacement of a closure installed within an aperture of a building, the method comprising the steps of:
removing a closure frame from its location within the building aperture;
positioning a sealing frame according to claim 1 within the building aperture;
inserting a replacement closure frame of a replacement closure into an opening of the building aperture;
translating the replacement closure frame along a depth axis of the building aperture in a direction away from the opening to a mounting location at which a surface of the replacement closure frame contacts an abutment surface defined by the sealing component; and
securing the replacement closure frame to the building at the mounting location.

22. A method of renovating a building involving the replacement of a closure which has been installed within an aperture of a building employing the method of claim 20, the method comprising the steps of:
removing the closure frame from its location within the building aperture;
inserting a replacement closure frame of a replacement closure into the opening of the building aperture;
translating the replacement closure frame along a depth axis of the building aperture in a direction away from the opening to the mounting location, at which a surface of the replacement closure frame contacts the abutment surface defined by the sealing component; and
securing the replacement closure frame to the building at the mounting location.

23. (canceled)

24. A method of installing a closure within an aperture of a building, the method comprising the steps of:
positioning a sealing frame according to claim 6 within the building aperture;
inserting a closure frame into an opening of the building aperture;
translating the closure frame along a depth axis of the building aperture in a direction away from the opening to a mounting location at which a surface of the closure frame contacts an abutment surface defined by the sealing component; and
securing the closure frame to the building at the mounting location.

25. A method of installing a closure within an aperture of a building, the method comprising the steps of:
positioning a sealing frame according to claim 10 within the building aperture;
inserting a closure frame into an opening of the building aperture;
translating the closure frame along a depth axis of the building aperture in a direction away from the opening to a mounting location at which a surface of the closure frame contacts an abutment surface defined by the sealing component; and
securing the closure frame to the building at the mounting location.
